(19) United States
(12) Patent Application Publication
(10) Pub. No.: US 2024/0198255 A1
(43) Pub. Date: Jun. 20, 2024

(54) METHOD FOR THE SEPARATION OF ANIONIC, CATIONIC, NEUTRAL AND ZWITTERIONIC ARSENIC SPECIES

(71) Applicant: DIONEX CORPORATION, Sunnyvale, CA (US)

(72) Inventors: John Edward Madden, Sunnyvale, CA (US); Charanjit Saini, San Ramon, CA (US); Yan Liu, Palo Alto, CA (US)

(21) Appl. No.: 18/067,711

(22) Filed: Dec. 18, 2022

(51) Int. Cl. B01D 15/36; B01J 39/05

(52) U.S. Cl. CPC B01D 15/364; B01J 39/05

(57) ABSTRACT

A method comprising separating a plurality of arsenic species using a mixed mode column and a strong acid. The plurality of arsenic species includes at least one of each of an anionic arsenic species, a cationic arsenic species, a neutral arsenic species, and a zwitterionic arsenic species.

### FIELD

The present disclosure generally relates to the field of chromatography including methods for the separation of anionic, cationic, neutral and zwitterionic arsenic species.

### INTRODUCTION

Chromatography, particularly ion chromatography (IC), is a widely used analytical technique for the determination of anionic and cationic analytes in various sample matrices. The analysis of Arsenic species by IC-MS typically uses a chromatographic column that can be operated with either a basic eluent or an acidic eluent. When using basic eluents, neutral and cationic arsenic species are typically poorly retained on the column due to poor ionization. When using acidic eluents, all arsenic species are ionized making retention possible. However the typical acid of choice, nitric acid, is too strong of an anionic eluent (nitrate ion), which results in little retention and thus poor separation of anionic species. As such, there is a need for improved methods for analyzing Arsenic species.

In “Separation of organic and inorganic arsenic species by HPLC-ICP-MS” (Fresenius J Anal Chem (1999) 363:577-581), Londesborough et al. disclose that while separation of some arsenic species is possible using a nitric acid gradient, monomethylarsonic acid coelutes with arsenate and trimethylarsine oxide coelutes with tetramethylarsonium ion. Londesborough et al. show partial separation of trimethylarsine oxide, arsenocholine, and tetramethylarsonium ion is possible with the addition of eluent modifiers.

In “Metal species determination by ion Chromatography” (Trends in analytical chemistry, vol. 20, nos. 6+7, 2001), Sarzanini et al. show that separation of arsenite, arsenate, monomethylarsonate, dimethylarsinate, trimethylarsine

oxide, tetramethylarsonium ion, arsenobetaine and arsenocholine can be achieved through the use of both an anion exchange column and cation exchange column.

### SUMMARY

In a first aspect, a method can include separating a plurality of arsenic species using a mixed mode column and a strong acid, the plurality of arsenic species including at least one of each of an anionic arsenic species, a cationic arsenic species, a neutral arsenic species, and a zwitterionic arsenic species.

In various embodiments of the first aspect, the anionic arsenic species can be selected from the group consisting of arsenite, methylarsonate, dimethylarsinate, phenylarsonate, and arsenate.

In various embodiments of the first aspect, the neutral arsenic species can include trimethylarsinoxide.

In various embodiments of the first aspect, the zwitterionic arsenic species can include arsenobetaine.

In various embodiments of the first aspect, the cationic arsenic species can be selected from the group consisting of arsenocholine and tetramethylarsonium.

In various embodiments of the first aspect, the mixed mode column can include a stationary phase with anionic and cationic functional groups.

In various embodiments of the first aspect, the strong acid can have a pKa less than 2.0.

In various embodiments of the first aspect, the strong acid can include methanesulfonic acid, ethanesulfonic acid, hydrochloric acid, hydrobromic acid, iodic acid, chloric acid, or any combination thereof.

In various embodiments of the first aspect, separating the plurality of arsenic species can further uses an organic solvent.

In a second aspect, a method can include separating a plurality of arsenic species using a chromatography column and a strong acid having a counter ion, the counter ion including a weaker anion exchange species than NO₃⁻.

In various embodiments of the second aspect, the plurality of arsenic species can include an anionic arsenic species selected from the group consisting of arsenite, methylarsonate, dimethylarsinate, phenylarsonate, and arsenate.

In various embodiments of the second aspect, the neutral arsenic species can be selected from the group consisting of trimethylarsinoxide.

In various embodiments of the second aspect, the plurality of arsenic species can include a zwitterionic arsenic species. In particular embodiments, the zwitterionic arsenic species can include arsenobetaine.

In various embodiments of the second aspect, the plurality of arsenic species can include a cationic arsenic species selected from the group consisting of arsenocholine and tetramethylarsonium.

In various embodiments of the second aspect, chromatography column can be a mixed mode column, and the mixed mode column can include a stationary phase with anionic and cationic functional groups.

In various embodiments of the second aspect, the strong acid can have a pKa less than 2.

In various embodiments of the second aspect, the strong acid can include methanesulfonic acid, ethanesulfonic acid, hydrochloric acid, hydrobromic acid, iodic acid, chloric acid, or any combination thereof.

In various embodiments of the second aspect, separating the plurality of arsenic species can further use an organic solvent.

In a third aspect, a method can include separating a plurality of arsenic species using a chromatography column and a strong acid, the plurality of arsenic species including at least two anionic arsenic species.

In various embodiments of the third aspect, the anionic arsenic species can be selected from the group consisting of arsenite, methylarsonate, dimethylarsinate, phenylarsonate, and arsenate.

In various embodiments of the third aspect, the plurality of arsenic species can further include at least one zwitterionic arsenic species, at least one neutral arsenic species, or at least one cationic arsenic species. In particular embodiments, the neutral arsenic species can include dimethylarsinate. In particular embodiments, the zwitterionic arsenic can include arsenobetaine. In particular embodiments, the cationic arsenic species can be selected from the group consisting of arsenocholine and tetramethylarsonium.

In various embodiments of the third aspect, the chromatography column can be a mixed mode column and the mixed mode column can include a stationary phase with anionic and cationic functional groups.

In various embodiments of the third aspect, the strong acid can have a counter ion that is a weaker anion exchange species than NO₃⁻.

In various embodiments of the third aspect, the strong acid can have a pKa less than 2.

In various embodiments of the third aspect, the strong acid can include methanesulfonic acid, ethanesulfonic acid, hydrochloric acid, hydrobromic acid, iodic acid, chloric acid, or any combination thereof.

In various embodiments of the third aspect, separating the plurality of arsenic species can further use an organic solvent.

### DRAWINGS

For a more complete understanding of the principles disclosed herein, and the advantages thereof, reference is now made to the following descriptions taken in conjunction with the accompanying drawings and exhibits, in which:

FIG. 1 is a block diagram of an exemplary chromatography system, in accordance with various embodiments.

FIG. 2 is a flow diagram illustrating an exemplary method for analyzing arsenic species in a sample, in accordance with various embodiments.

FIGS. 3, 4, and 5 are chromatograms showing separation of various arsenic species.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DESCRIPTION OF VARIOUS EMBODIMENTS

Embodiments of methods for the separation of anionic, cationic, neutral and zwitterionic arsenic species are described herein and in the accompanying exhibits.

The section headings used herein are for organizational purposes only and are not to be construed as limiting the described subject matter in any way.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless described otherwise, all technical and scientific terms used herein have a meaning as is commonly understood by one of ordinary skill in the art to which the various embodiments described herein belongs.

It will be appreciated that there is an implied “about” prior to the temperatures, concentrations, times, pressures, flow rates, cross-sectional areas, etc. discussed in the present teachings, such that slight and insubstantial deviations are within the scope of the present teachings. In this application, the use of the singular includes the plural unless specifically stated otherwise. Also, the use of “comprise”, “comprises”, “comprising”, “contain”, “contains”, “containing”, “include”, “includes”, and “including” are not intended to be limiting. It is to be understood that both the foregoing general description and the following detailed description are exemplary and explanatory only and are not restrictive of the present teachings.

As used herein, “a” or “an” also may refer to “at least one” or “one or more.” Also, the use of “or” is inclusive, such that the phrase “A or B” is true when “A” is true, “B” is true, or both “A” and “B” are true. Further, unless otherwise required by context, singular terms shall include pluralities and plural terms shall include the singular.

A “system” sets forth a set of components, real or abstract, comprising a whole where each component interacts with or is related to at least one other component within the whole.

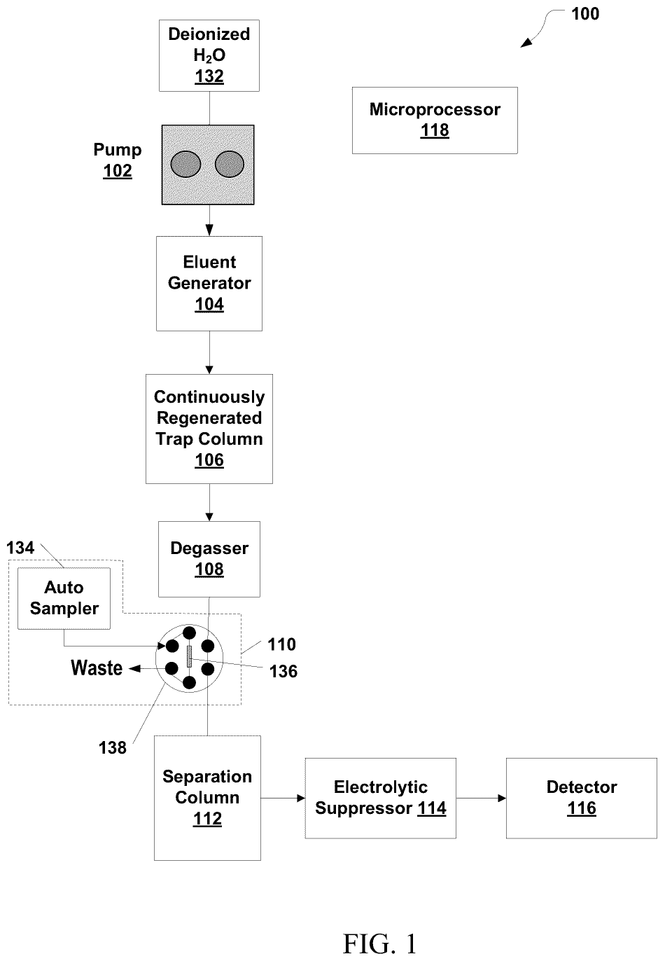

FIG. 1 illustrates an embodiment of a chromatography system 100. Chromatography system 100 may include a pump 102, an electrolytic eluent generator 104, a continuously regenerated trap column 106, a degasser 108, a sample injector 110, a chromatographic separation device 112, an electrolytic suppressor 114, a detector 116, and a microprocessor 118. Chromatographic separation device 112 may be in the form of a capillary column or an analytical column.

Pump 102 can be configured to pump a liquid from a liquid source 132, such as deionized water, and be fluidically connected to electrolytic eluent generator 104. Pump 102 may be in the form of a high-pressure liquid chromatography (HPLC) pump.

An eluent is a liquid that contains an acid, base, salt, or mixture thereof and can be used to elute an analyte through a chromatography column. In addition, an eluent can include a mixture of a liquid and a water miscible organic solvent, where the liquid may include an acid, base, salt, or combination thereof. Electrolytic eluent generator 104 is configured to generate an eluent species. An eluent species refers to a particular species of acid, base, or salt that can be added to the eluent. In an embodiment, the eluent species may be a base such as potassium hydroxide or the eluent species may be an acid such as carbonic acid, phosphoric acid, acetic acid, methanesulfonic acid, or a combination thereof. An eluent may contain organic solvents such as acetonitrile and methanol.

Referring to FIG. 1, eluent generator 104 can be configured to receive the liquid from pump 102 and then add an eluent species to the liquid. The liquid containing the eluent species can be outputted from eluent generator 104 to an inlet of continuously regenerated trap column 106.

Continuously regenerated trap column 106 is configured to remove cationic or anionic contaminants from the eluent. Continuously regenerated trap column 106 can include an ion exchange bed with an electrode at the eluent outlet. An ion exchange membrane stack can separate the eluent from a second electrode and contaminate ions can be swept through the ion exchange membrane stack towards the second electrode. The ion exchange membrane stack can include one or more ion exchange membranes. In various embodiments, anion removal can utilize an anion exchange bed with a cathode at the eluent outlet separated from an anode by an anion exchange membrane. Alternatively, cation removal can utilize a cation exchange bed with an anode at the eluent outlet separated from a cathode by a cation exchange membrane.

Degasser 108 may be used to remove residual gas. In an embodiment, a residual gas may be electrolytically generated such as hydrogen and oxygen. Degasser 108 may include a tubing section that is gas permeable and liquid impermeable such as, for example, amorphous fluoropolymers or more specifically Teflon AF. The flowing liquid can be outputted from degasser 108 to sample injector 110 with a substantial portion of the gas removed.

Sample Injector 110 can be used to inject a bolus of a liquid sample into an eluent stream. The liquid sample may include a plurality of chemical constituents (i.e., matrix components) and one or more analytes of interest. The sample injector 110 can include an auto sampler 134, sample loop 136, and a multiport valve 138. The auto sampler 134 can draw a sample from a sample container. The multiport valve 138 can be in a first position to allow the sample to fill the sample loop 136. After the sample loop 136 is filled to the desired level, the multiport valve can switch to a second position and the eluent stream can drive the sample onto the chromatographic separation device 112.

Chromatographic separation device 112 can be used to separate various matrix components present in the liquid sample from the analyte(s) of interest. Typically, chromatographic separation device 112 may be in the form of a hollow cylinder that contains a packed stationary phase. As the liquid sample flows through chromatographic separation device 112, the matrix components and target analytes can have a range of retention times for eluting off of chromatographic separation device 112. Depending on the characteristics of the target analytes and matrix components, they can have different affinities to the stationary phase in chromatographic separation device 112. An output of chromatographic separation device 112 can be fluidically connected to electrolytic suppressor 114.

Suppressor 114 can be used to reduce eluent conductivity background and enhance analyte response through efficient exchange of eluent counterions for regenerant ions. One type of suppressor is an electrolytic suppressor 114 can include an anode chamber, a cathode chamber, and an eluent suppression bed chamber separated by ion exchange membranes. The anode chamber and/or cathode chamber can produce regenerate ions or transport supplied regenerant ions. The eluent suppression bed chamber can include a flow path for the eluent separated from the regenerant by an ion exchange barrier and eluent counterions can be exchanged with regenerate ions across the ion exchange barrier. An output of electrolytic suppressor 114 can be fluidically connected to detector 116 to measure the presence of the separated chemical constituents of the liquid sample. The suppressor 114 can also be of the chemical kind that requires a chemical regenerant for operation. Any suppressor in the prior art is suited for the present application with multiple channels as configured.

Detector 116 may be in the form of ultraviolet-visible spectrometer, a fluorescence spectrometer, atomic fluorescence detector, atomic emission spectrometer, a refractive index detector, a radio flow detector, a chiral detector, an electrochemical detector, a conductivity detector, a mass spectrometer, a flame ionization detector, or a combination thereof.

An electronic circuit may include microprocessor 118, a timer, and a memory portion. In addition, the electronic circuit may include a power supply that are configured to apply a controlling signal, respectively. Microprocessor 118 can be used to control the operation of chromatography system 100. Microprocessor 118 may either be integrated into chromatography system 100 or be part of a personal computer that communicates with chromatography system 100. Microprocessor 118 may be configured to communicate with and control one or more components of chromatography system such as pump 102, pump 130, eluent generator 104, sample injector 110, and detector 116. The memory portion may be used to store instructions to set the magnitude and timing of the current waveform with respect to the switching of sample injector 110 that injects the sample.

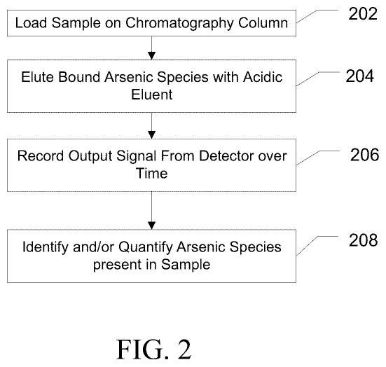

FIG. 2 is a flow diagram illustrating a method 200 of analyzing a sample containing arsenic species. At 202, the sample is injected into the chromatography column. Depending on the sample, various pre-injection sample preparation steps can be taken. In various embodiments, a solid or semi-solid sample may be ground up and suspended in a solution to extract the arsenic species. The liquid solution can be separated from the solid material and injected into the column. In other embodiments, the sample can be a liquid sample, such as a water sample, and can be injected directly onto the column without significant pre-injection sample preparation. The sample can include a plurality of arsenic species, including anionic arsenic species, a cationic arsenic species, a neutral arsenic species, and a zwitterionic arsenic species. In various embodiments, the sample can include at least two anionic arsenic species. In various embodiments, the sample can include anionic arsenic species and any combination of cationic arsenic species, neutral arsenic species, and zwitterionic arsenic species. For example, the sample can include one or more anionic arsenic species and at least one of a cationic arsenic species, a neutral arsenic species, and a zwitterionic arsenic species. In another example, the sample can include at least one of each of an anionic arsenic species, a cationic arsenic species, a neutral arsenic species, and a zwitterionic arsenic species.

Anionic arsenic species can behave as anions at all pH. Examples of the anionic arsenic species include arsenite, methylarsonate, dimethylarsinate, phenylarsonate, and arsenate. Neutral arsenic species can behave as cations at low pH. Trimethylarsinoxide is an example of a neutral arsenic species. Zwitterionic arsenic species include both anionic and cationic groups and can behave as cations at low pH when the anionic groups are neutralized. Arsenobetaine is an example of a zwitterionic arsenic species. Cationic arsenic species can behave as cations at all pH. Examples of the anionic arsenic species include arsenocholine and tetramethylarsonium.

The column can include a mixed mode stationary phase. Mixed mode stationary phases include functional groups of with two or more different properties, such as cationic functional groups, anionic functional groups, polar groups, and the like. In particular embodiments, the mixed mode stationary phase includes anionic functional groups and cationic functional groups. The arsenic species can be retained on the column by binding to the functional groups.

At 204, the bound arsenic species can be eluted from the column with an acidic eluent. The acid eluent can include a strong acid, such as an acid having a pKa of less than 2.0. The strong acid can include a hydronium ion and a weak anionic eluent species, such as an anionic eluent species that is a weaker anion exchange species than NO₃⁻. Examples of strong acids with weak anionic eluent species can include methanesulfonic acid, ethanesulfonic acid, hydrochloric acid, hydrobromic acid, iodic acid, and chloric acid.

At 206, the output of a detector can be recorded over time, and at 208, the detector output can be used to identify or quantify the arsenic species present in the sample. In particular embodiments, the detector can be an arsenic selective detector, such as a mass spectrometer. For example, method 200 can be performed by an ion chromatography-mass spectrometer (IC-MS).

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

Any of the operations that form part of the embodiments described herein are useful machine operations. The embodiments, described herein, also relate to a device or an apparatus for performing these operations. The systems and methods described herein can be specially constructed for the required purposes or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

### Examples

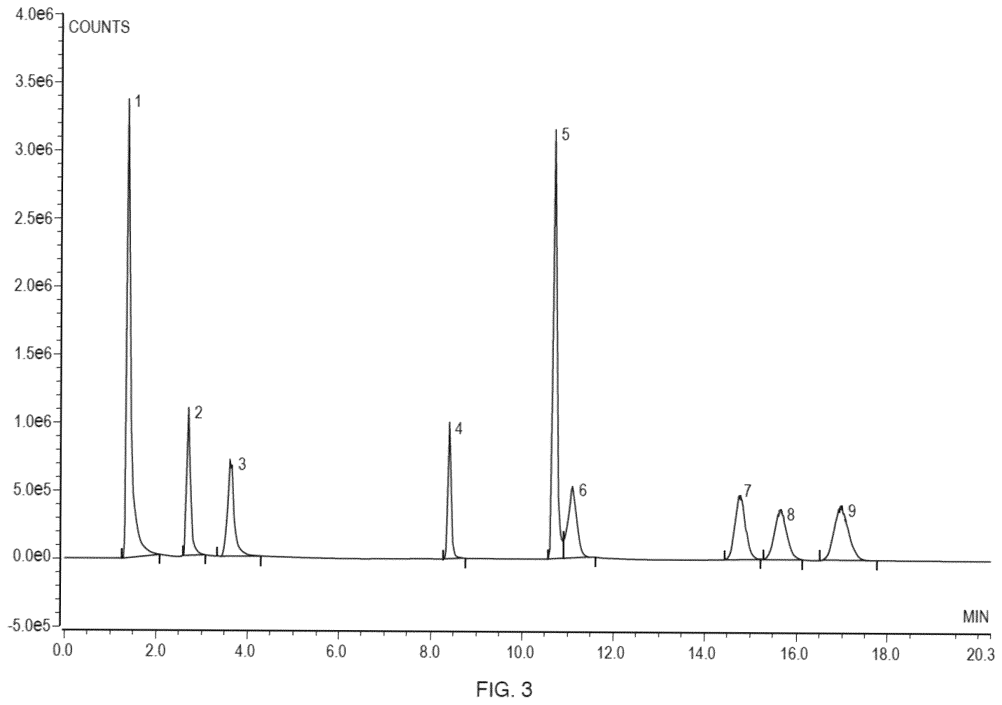

FIG. 3 is a chromatogram showing the separation of a sample including nine arsenic species. The separation uses an IonPac AS7 column with methanesulfonic acid as an eluent. From 0 to 5 minutes, the methanesulfonic acid is at a concentration of 2.0 mM, increasing to 20 mM from 5 to 10 minutes, and then maintained at 20 mM from 10 to 25 minutes. The sample includes (1) arsenite, (2) methylarsonate, (3) dimethylarsinate, (4) phenylarsonate, (5) arsenate, (6) arsenobetaine, (7) timethylarsinoxide, (8) arsenocholine, and (9) tetramethylarsonium.

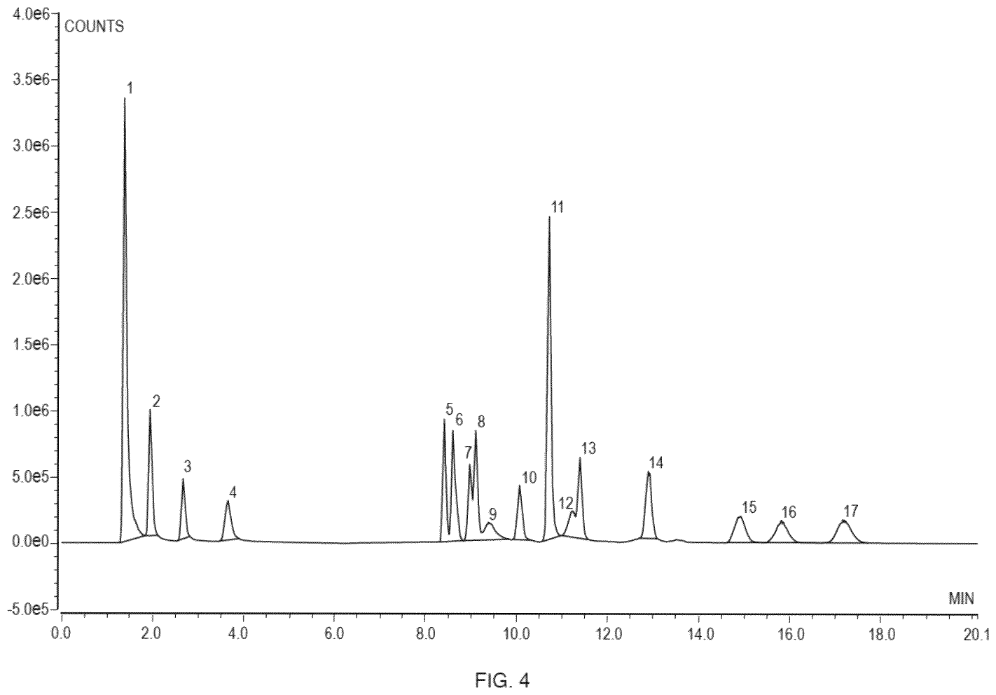

FIG. 4 is a chromatogram showing the separation of a sample including 17 arsenic species. The separation uses an IonPac AS7 column with methanesulfonic acid as an eluent. From 0 to 5 minutes, the methanesulfonic acid is at a concentration of 2.0 mM, increasing to 20 mM from 5 to 10 minutes, and then maintained at 20 mM from 10 to 25 minutes. The sample includes (1) arsenite, (2) phenylarsine oxide, (3) methylarsonate. (4) dimethylarsinate. (5) phenylarsonate, (6) 2-nitrophenylarsonate, (7) 2-aminophenylarsonate, (8) 4-hydroxyphenylarsonate, (9) p-arsanilate, (10) carbarsone, (11) arsenate, (12) arsenobetaine, (13) nitarsone, (14) roxarsone, (15) timethylarsinoxide, (16) arsenocholine, and (17) tetramethylarsonium.

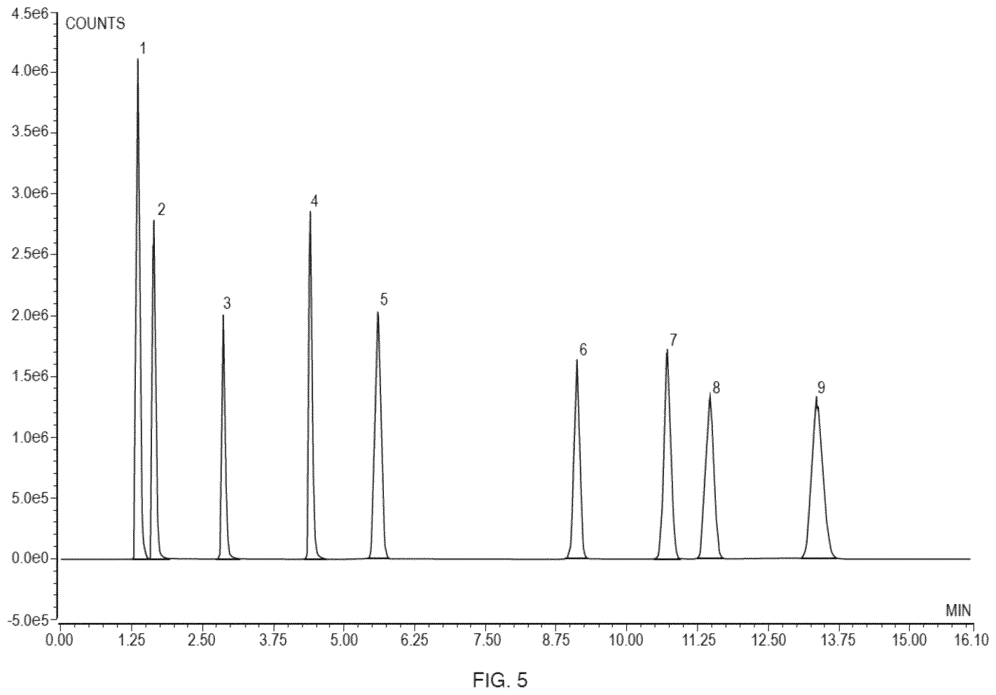

FIG. 5 is a chromatogram showing the separation of a sample including nine arsenic species. The separation uses an IonPac CS5A column with methanesulfonic acid as an eluent. From 0 to 2 minutes, the methanesulfonic acid is at a concentration of 2.0 mM, increasing to 6 mM from 2 to 8 minutes, and then increasing to 80 mM from 8 to 20 minutes. The sample includes (1) arsenite. (2) methylarsonate. (3) phenylarsonate. (4) arsenate. (5) dimethylarsinate. (6) arsenobetaine. (7) timethylarsinoxide. (8) arsenocholine, and (9) tetramethylarsonium.

What is claimed is:

1. A method comprising:
separating a plurality of arsenic species using a mixed mode column and a strong acid, the plurality of arsenic species including at least one of each of an anionic arsenic species, a cationic arsenic species, a neutral arsenic species, and a zwitterionic arsenic species.

2. The method of claim 1 wherein the anionic arsenic species is selected from the group consisting of arsenite, methylarsonate, dimethylarsinate, phenylarsonate, and arsenate.

3. The method of claim 1 wherein the neutral arsenic species includes trimethylarsinoxide.

4. The method of claim 1 wherein the zwitterionic arsenic species includes arsenobetaine.

5. The method of claim 1 wherein the cationic arsenic species is selected from the group consisting of arsenocholine and tetramethylarsonium.

6. The method of claim 1 wherein the mixed mode column includes a stationary phase with anionic and cationic functional groups.

7. The method of claim 1 wherein the strong acid has a pKₐ less than 2.0.

8. The method of claim 1 wherein the strong acid includes methanesulfonic acid, ethanesulfonic acid, hydrochloric acid, hydrobromic acid, iodic acid, chloric acid, or any combination thereof.

9. The method of claim 1 wherein separating the plurality of arsenic species further uses an organic solvent.

10. A method comprising:
separating a plurality of arsenic species using a chromatography column and a strong acid having a counter ion, the counter ion including a weaker anion exchange species than NO₃⁻.

11. The method of claim 10 wherein the plurality of arsenic species includes an anionic arsenic species selected from the group consisting of arsenite, methylarsonate, dimethylarsinate, phenylarsonate, and arsenate.

12. The method of claim 10 wherein the neutral arsenic species is selected from the group consisting of trimethylarsinoxide.

13. The method of claim 10 wherein the plurality of arsenic species includes a zwitterionic arsenic species.

14. The method of claim 13 wherein the zwitterionic arsenic species includes arsenobetaine.

15. The method of claim 10 wherein the plurality of arsenic species includes a cationic arsenic species selected from the group consisting of arsenocholine and tetramethylarsonium.

16. The method of claim 10 wherein chromatography column is a mixed mode column, and the mixed mode column includes a stationary phase with anionic and cationic functional groups.

17. The method of claim 10 wherein the strong acid has a pKₐ less than 2.

18. The method of claim 10 wherein the strong acid includes methanesulfonic acid, ethanesulfonic acid, hydrochloric acid, hydrobromic acid, iodic acid, chloric acid, or any combination thereof.

19. The method of claim 10 wherein separating the plurality of arsenic species further uses an organic solvent.

20. A method comprising:
separating a plurality of arsenic species using a chromatography column and a strong acid, the plurality of arsenic species including at least two anionic arsenic species.

21. The method of claim 20 wherein the anionic arsenic species is selected from the group consisting of arsenite, methylarsonate, dimethylarsinate, phenylarsonate, and arsenate.

22. The method of claim 20 wherein the plurality of arsenic species further includes at least one zwitterionic arsenic species, at least one neutral arsenic species, or at least one cationic arsenic species.

23. The method of claim 22 wherein the neutral arsenic species includes dimethylarsinate.

24. The method of claim 22 wherein the zwitterionic arsenic includes arsenobetaine.

25. The method of claim 22 wherein the cationic arsenic species is selected from the group consisting of arsenocholine and tetramethylarsonium.

26. The method of claim 20 wherein the chromatography column is a mixed mode column and the mixed mode column includes a stationary phase with anionic and cationic functional groups.

27. The method of claim 20 wherein the strong acid has a counter ion that is a weaker anion exchange species than NO₃⁻.

28. The method of claim 20 wherein the strong acid has a pKₐ less than 2.

29. The method of claim 20 wherein the strong acid includes methanesulfonic acid, ethanesulfonic acid, hydrochloric acid, hydrobromic acid, iodic acid, chloric acid, or any combination thereof.

30. The method of claim 20 wherein separating the plurality of arsenic species further uses an organic solvent.
